(19) United States
(12) Patent Application Publication
(10) Pub. No.: US 2026/0054637 A1
(43) Pub. Date: Feb. 26, 2026

(54) DEACTIVATION OF ONE TOUCH TURN SIGNAL AS FUNCTION OF VEHICLE TRAVERSAL VELOCITY

(71) Applicants: Hyundai Motor Company, Seoul (KR); Kia Corporation, Seoul (KR)

(72) Inventors: Rijan Malla, Superior Township, MI (US); Brian Link, Superior Township, MI (US); Jason D. Valentini, Superior Township, MI (US)

(21) Appl. No.: 18/811,423

(22) Filed: Aug. 21, 2024

(51) Int. Cl. B60Q 1/34; G01P 7/00

(52) U.S. Cl. CPC B60Q 1/343; G01P 7/00; B60Q 2900/50

(57) ABSTRACT

Systems and methods for deactivating one-touch turn signals as a function of vehicle traversal velocity are provided. The method may comprise, using a computing device comprising a processor and a memory, determining, using a turn signal switch, whether a turn signal of a vehicle is activated, determining whether a lane crossing is detected, and, when a lane crossing is detected, calculating a vehicle traversal velocity, comparing the traversal velocity to a first threshold, and, when the traversal velocity is less than the first threshold, deactivating the turn signal when an elapsed time is greater than a second threshold.

### BACKGROUND

### Technical Field

Embodiments of the present disclosure relate to systems and methods for controlling vehicle turn signals and, in particular, to systems and methods for deactivating one-touch turn signals as a function of vehicle traversal velocity.

### Background

Vehicles often implement turn signals to indicate when that the vehicle is going to turn and the direction of the turn. In a traditional turn signal feature, a turn signal may be activated and remain activated until manually deactivated and/or when the steering wheel crosses a threshold and returns to center, at which point the turn signal will deactivate.

An enhanced turn signal feature is the one-touch turn signal. The one-touch turn signal feature allows for the activation of turn signal flashers a preset number of times in the absence of the steering wheel crossing a threshold and returning to center, unlike in traditional turn signals. Current implementations of one-touch turn signals have a preset number (e.g., 3, 5, 7, etc.) of turn signal flashes, which may result in turn signal flashing for too short or too long, depending on the individual driving maneuver and/or scenario.

As shown, e.g., in FIGS. 1A-1B, a turn signal activation mechanism may be configured to have a neutral position, a left one-touch position (to activate the left one-touch turn signal), a right one-touch position (to activate the right one-touch turn signal), a left detent position (to activate the left traditional turn signal), and/or a right detent position (to activate the right traditional turn signal).

There is no one size that fits all need depending on specific driving situations. For example, when a driver performs a fast lane change, 3 blinks may suffice, whereas, when a slow change is desired, 5 blinks may not be enough.

Additionally, during extreme road curvature and high-speed driving maneuvers (especially with high traffic conditions), such as entering a highway, exiting highway, or lane changes in curved highways (as shown, e.g., in FIGS. 2A-2B), deactivating the turn signal requires additional cognitive and physical effort on the driver. Furthermore, when multiple lane traversal, either to shift lanes or to take a highway exit from distant lane, more than one activation of the one-touch turn signal may be needed.

For at least these reasons, systems and methods that provide and enable one-turn turn signals that are intelligent and adaptive to various driving maneuvers and/or scenarios are needed. Such systems and methods would improve the customer driving experience.

### SUMMARY

According to an object of the present disclosure, a method for deactivating one-touch turn signals as a function of vehicle traversal velocity is provided. The method may comprise, using a computing device comprising a processor and a memory, determining, using a turn signal switch, whether a turn signal of a vehicle is activated, determining whether a lane crossing is detected, and, when a lane crossing is detected, calculating a vehicle traversal velocity, comparing the traversal velocity to a first threshold, and, when the traversal velocity is less than the first threshold, deactivating the turn signal when an elapsed time is greater than a second threshold.

According to an exemplary embodiment, the method may further comprise, prior to determining whether the lane crossing is detected, determining whether a steering wheel angle is returned to center, and, when the steering wheel angle is not returned to center, determining whether manual deactivation of the turn signal is requested.

According to an exemplary embodiment, the determining whether the lane crossing is detected may comprise determining whether a first wheel of the vehicle is within a lane line on a road, determining whether the first wheel has crossed the lane line when the first wheel of the vehicle is determined to be within the lane line, determining whether a second wheel has crossed the lane line when the first wheel is determined to have crossed the lane line, and detecting a lane crossing when the first wheel and the second wheel are determined to have crossed the lane line.

According to an exemplary embodiment, the calculating the vehicle traversal velocity may comprise determining, using the computing device, an inertial measurement unit, and one or more cameras, a vehicle lateral acceleration, a vehicle yaw rate, a land line curvature, and a vehicle longitudinal velocity, and calculating the vehicle traversal velocity, according to:

$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$

In the above equation, v_{t-y} is the local vehicle traversal velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and k_{σ} is the road curvature gradient threshold (rad/s).

According to an exemplary embodiment, the method may further comprise, when the lane crossing is not detected, characterizing lane line dynamics, wherein characterizing lane line dynamics comprises determining whether the lane lines conform to a roundabout, when the lane lines conform to a roundabout, characterizing the lane lines as a roundabout, determining whether the lane lines conform to a fork/split, when the lane lines conform to a fork/split, characterizing the lane lines as a fork/split, determining whether the lane lines conform to a ramp, and, when the lane lines conform to a ramp, characterizing the lane lines as a ramp.

According to an exemplary embodiment, the method may further comprise, after characterizing the lane line dynamics, determining whether a deactivation event is detected.

According to an exemplary embodiment, the method may further comprise, when a deactivation event is detected, deactivating the turn signal when the elapsed time is greater than the second threshold.

According to an object of the present disclosure, a system for deactivating one-touch turn signals as a function of vehicle traversal velocity is provided. The system may comprise a vehicle. The vehicle may comprise a turn signal switch configured to activate a turn signal, and a computing device comprising a processor and a memory. The computing device may be configured to determine, using a turn signal switch, whether a turn signal of a vehicle is activated, determine whether a lane crossing is detected, and, when a lane crossing is detected calculate a vehicle traversal velocity, compare the traversal velocity to a first threshold, and, when the traversal velocity is less than the first threshold, deactivate the turn signal when an elapsed time is greater than a second threshold.

According to an exemplary embodiment, the vehicle may further comprise a steering wheel, and the computing device, prior to determining whether the lane crossing is detected, may be configured to determine whether a steering wheel angle is returned to center, and, when the steering wheel angle is not returned to center, determine whether manual deactivation of the turn signal is requested.

According to an exemplary embodiment, the determining whether the lane crossing is detected may comprise determining whether a first wheel of the vehicle is within a lane line on a road, determining whether the first wheel has crossed the lane line when the first wheel of the vehicle is determined to be within the lane line, determining whether a second wheel has crossed the lane line when the first wheel is determined to have crossed the lane line, and detecting a lane crossing when the first wheel and the second wheel are determined to have crossed the lane line.

According to an exemplary embodiment, the vehicle may further comprise an inertial measurement unit and one or more cameras, and calculating the vehicle traversal velocity may comprise determining, using the computing device, an inertial measurement unit, and one or more cameras, a vehicle lateral acceleration, a vehicle yaw rate, a land line curvature, and a vehicle longitudinal velocity, and calculating the vehicle traversal velocity, according to:

$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$

In the above equation, v_{t-y} is the local vehicle traversal velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and k_{σ} is the road curvature gradient threshold (rad/s).

According to an exemplary embodiment, the computing device may be further configured, when the lane crossing is not detected, to characterize lane line dynamics, wherein characterizing lane line dynamics comprises determining whether the lane lines conform to a roundabout, when the lane lines conform to a roundabout, characterizing the lane lines as a roundabout, determining whether the lane lines conform to a fork/split, when the lane lines conform to a fork/split, characterizing the lane lines as a fork/split, determining whether the lane lines conform to a ramp, and, when the lane lines conform to a ramp, characterizing the lane lines as a ramp.

According to an exemplary embodiment, the computing device may be further configured to determine, after characterizing the lane line dynamics, whether a deactivation event is detected.

According to an exemplary embodiment, the computing device may be further configured to deactivate, when a deactivation event is detected, the turn signal when the elapsed time is greater than the second threshold.

According to an object of the present disclosure, a system for deactivating one-touch turn signals as a function of vehicle traversal velocity is provided. The system may comprise a turn signal switch configured to activate a turn signal, and a computing device comprise a processor and a memory. The memory may be configured to store instructions that, when executed by the processor, are configured to cause the processor to determine, using a turn signal switch, whether a turn signal of a vehicle is activated, determine whether a lane crossing is detected, and, when a lane crossing is detected, calculate a vehicle traversal velocity, compare the traversal velocity to a first threshold, and, when the traversal velocity is less than the first threshold, deactivate the turn signal when an elapsed time is greater than a second threshold.

According to an exemplary embodiment, the instructions, when executed by the processor, may be further configured to cause the processor to determine whether a steering wheel angle is returned to center, and, when the steering wheel angle is not returned to center, determine whether manual deactivation of the turn signal is requested.

According to an exemplary embodiment, the determining whether the lane crossing is detected may comprise determining whether a first wheel of the vehicle is within a lane line on a road, determining whether the first wheel has crossed the lane line when the first wheel of the vehicle is determined to be within the lane line, determining whether a second wheel has crossed the lane line when the first wheel is determined to have crossed the lane line, and detecting a lane crossing when the first wheel and the second wheel are determined to have crossed the lane line.

According to an exemplary embodiment, the calculating the vehicle traversal velocity may comprise determining, using the computing device, an inertial measurement unit, and one or more cameras, a vehicle lateral acceleration, a vehicle yaw rate, a land line curvature, and a vehicle longitudinal velocity, and calculating the vehicle traversal velocity, according to:

$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$

In the above equation, v_{t-y} is the vehicle traversal velocity (m/s), a_{y} is the vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and k_{σ} is the road curvature gradient threshold (rad/s).

According to an exemplary embodiment, the instructions, when executed by the processor, may be further configured to cause the processor, when the lane crossing is not detected, to characterize lane line dynamics, wherein characterizing lane line dynamics comprises determining whether the lane lines conform to a roundabout, when the lane lines conform to a roundabout, characterizing the lane lines as a roundabout, determining whether the lane lines conform to a fork/split, when the lane lines conform to a fork/split, characterizing the lane lines as a fork/split, determining whether the lane lines conform to a ramp, and, when the lane lines conform to a ramp, characterizing the lane lines as a ramp.

According to an exemplary embodiment, the instructions, when executed by the processor, may be further configured to cause the processor to, determine, after characterizing the lane line dynamics, whether a deactivation event is detected, and deactivate, when a deactivation event is detected, the turn signal when the elapsed time is greater than the second threshold.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIGS. 1A-1B illustrate an example turn signal activation mechanism having a neutral position, a left one-touch position, a right one-touch position, a left detent position, and a right detent position, according to an exemplary embodiment of the present disclosure.

FIGS. 2A-2B illustrate example vehicles performing lane changes in curved highways, according to an exemplary embodiment of the present disclosure.

FIG. 3 illustrates a vehicle configured for deactivating one-touch turn signals as a function of vehicle traversal velocity, according to an exemplary embodiment of the present disclosure.

FIGS. 4A-4E illustrate an example flowchart of a method for deactivating one-touch turn signals as a function of vehicle traversal velocity, according to an exemplary embodiment of the present disclosure.

FIG. 5 illustrates an example vehicle performing a left lane line crossing, according to an exemplary embodiment of the present disclosure.

FIG. 6 illustrates an example diagram of a vehicle in relation to the path boundary and vehicle trajectory, according to an exemplary embodiment of the present disclosure.

FIG. 7 illustrates an example architecture of a vehicle, according to an exemplary embodiment of the present disclosure.

FIG. 8 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking.” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for controlling vehicle turn signals and, in particular, to systems and methods for deactivating one-touch turn signals as a function of vehicle traversal velocity are provided.

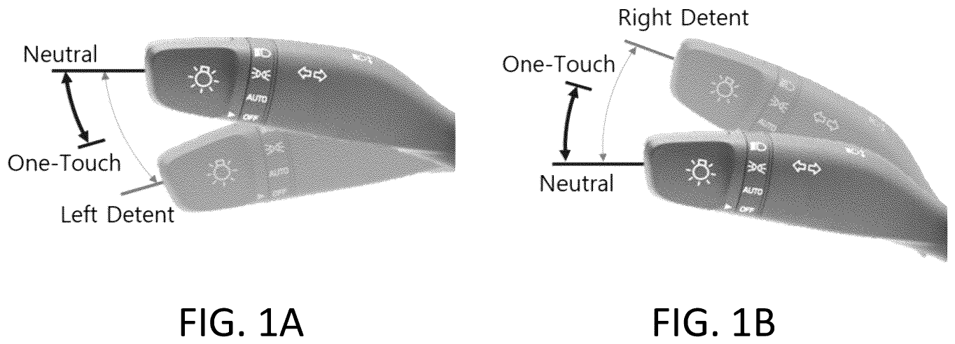

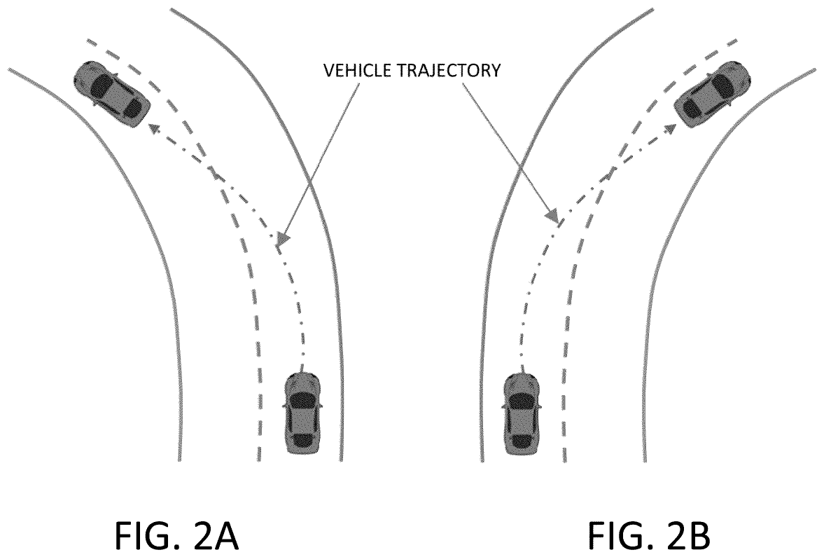

Referring now to FIG. 1, a vehicle 100 configured for deactivating one-touch turn signals as a function of vehicle traversal velocity, in accordance with an exemplary embodiment of the present disclosure.

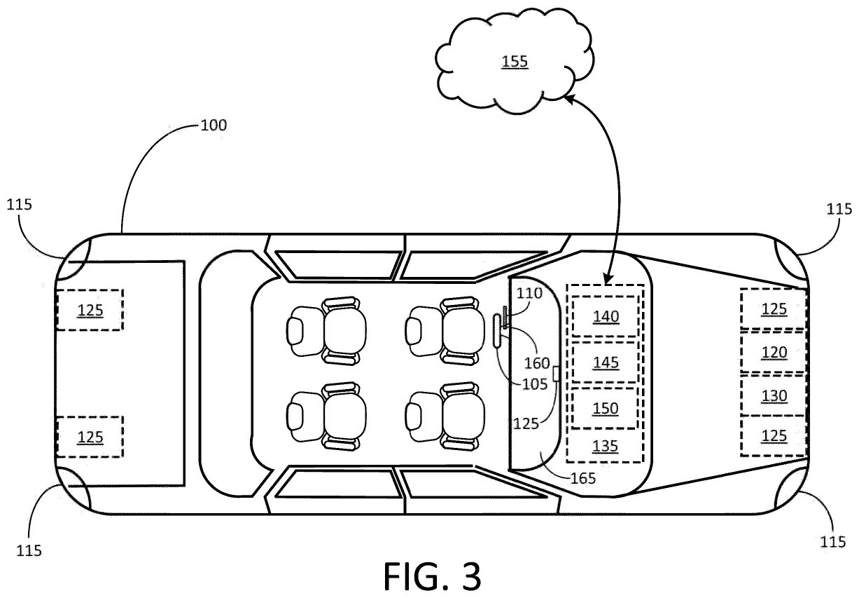

According to an exemplary embodiment, the vehicle 100 may comprise a steering device (e.g., the steering wheel 105 shown in FIG. 3) and a turn signal activation mechanism 110 (e.g., the turn signal stalk shown in FIGS. 1A-1B and 3) configured to activate a turn signal. According to an exemplary embodiment, the turn signal may be configured to control (e.g., blink) one or more turn signal indicators 115 (e.g., one or more turn signal lights). According to an exemplary embodiment, the turn signal activation mechanism 110 may comprise a turn signal switch 160 configured to cause a turn signal (e.g., a left one-touch turn signal, a right one-touch turn signal, a left traditional turn signal, a right traditional turn signal, etc.) to be generated.

According to an exemplary embodiment, the vehicle 100 may comprise one or more sensors such as, for example, an inertial measurement unit 120, one or more cameras 125 (e.g., one or more front view cameras, rear view cameras, one or more cameras positioned along a windshield 165, etc.), a steering wheel angle sensor 130, and/or other suitable sensors. According to an exemplary embodiment, the one or more sensors may be in electronic communication with one or more computing devices 135. The one or more computing devices 135 may be separate from the one or more sensors and/or may be incorporated into and/or coupled to the one or more sensors.

According to an exemplary embodiment, the computing device 135 may comprise a processor 140, a memory 145, and/or a user interface 150 (e.g., a graphical user interface). The computing device 135 may be configured to send and/or receive commands/data/etc. via one or more external systems via wired and/or wireless connection (e.g., via the cloud 155). The memory 145 may be configured to store programming instructions that, when executed by the processor 140, may be configured to cause the processor 140 to perform one or more tasks such as, e.g., determining whether the vehicle 100 will cross a road line (corresponding to a turn signal activation), comparing the vehicle's 100 traversal velocity with a threshold velocity to detect a completion of a turn, calculating the vehicle's 100 traversal acceleration, integrating the traversal acceleration to calculate the vehicle's 100 traversal velocity, calculating a delay, starting a delay timer, deactivating a turn signal when a turn completion is detected (e.g., when the vehicle's 100 traversal velocity is less than a traversal velocity threshold and a delay time is greater than a delay time threshold), and/or performing one or more other suitable tasks.

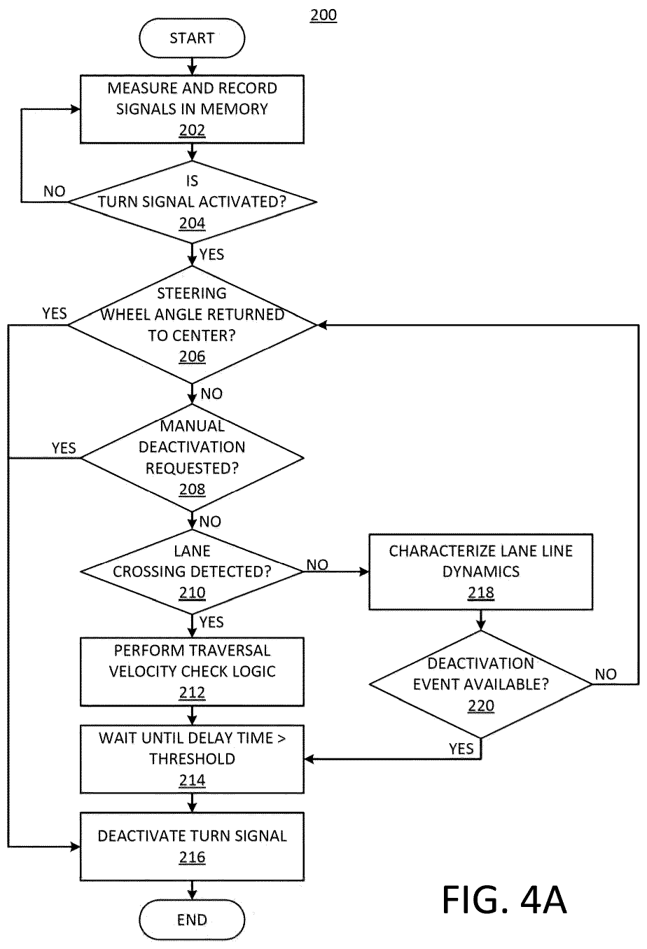

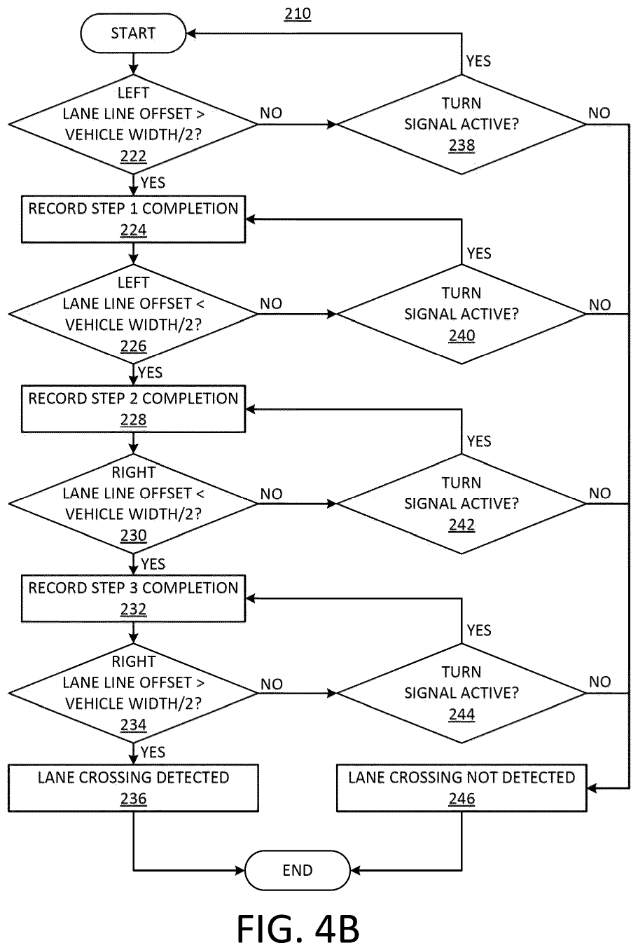

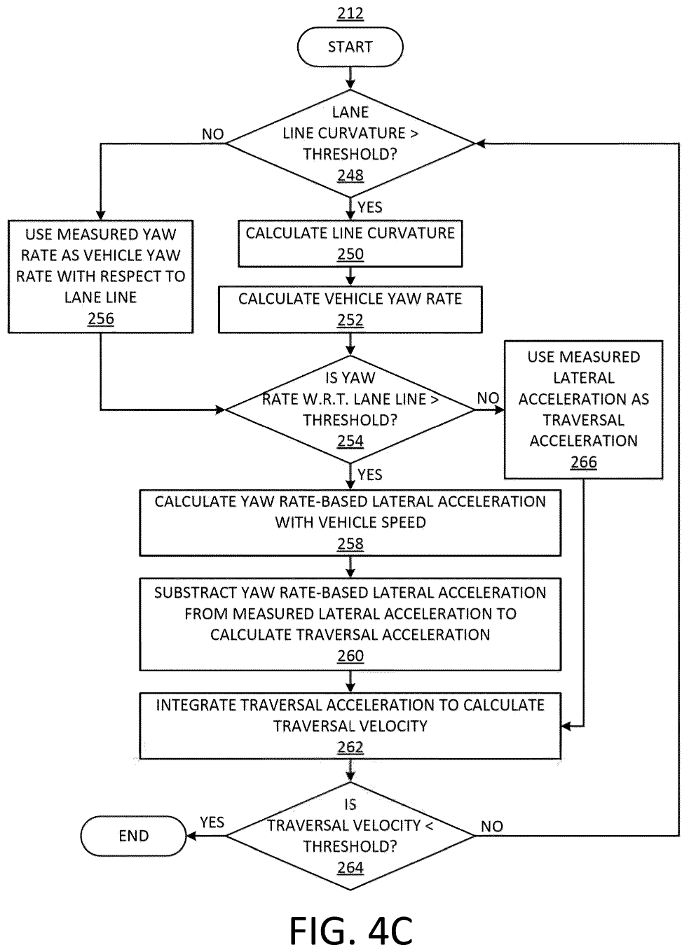

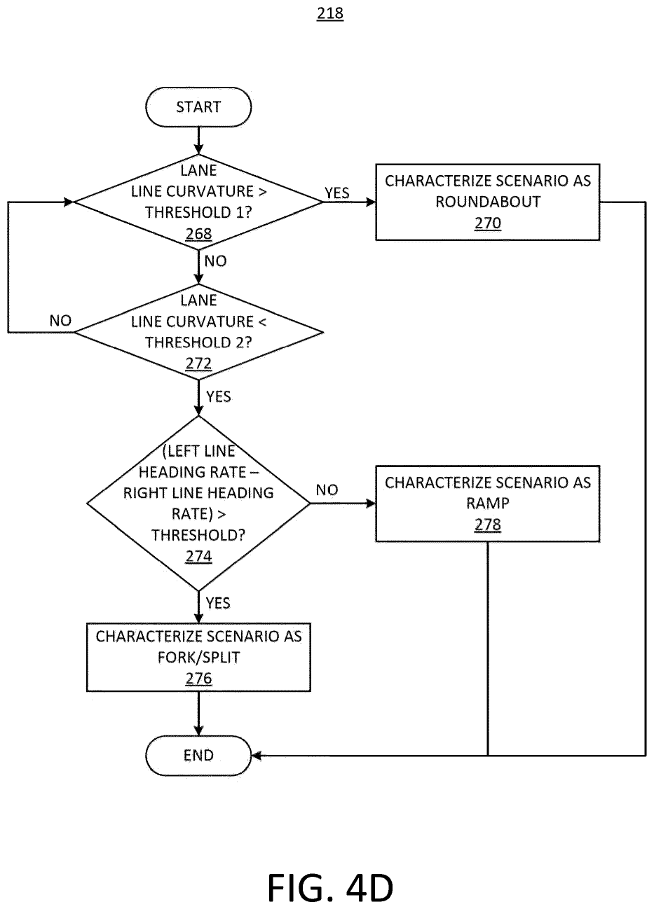

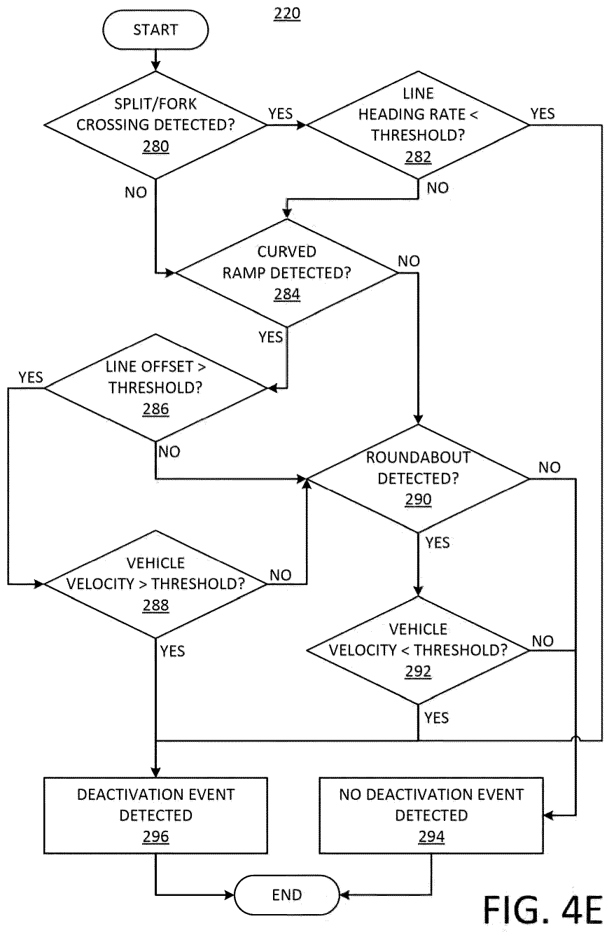

Referring now to FIGS. 4A-4E, flowchart of a method 200 for deactivating one-touch turn signals as a function of vehicle traversal velocity is illustratively depicted, in accordance with an exemplary embodiment of the present disclosure.

At 202, signals from the one or more sensors and/or switches (e.g., the inertial measurement unit, the one or more cameras, the steering wheel angle sensor, the turn signal switch, and/or other suitable sensors and/or switches) may be saved and recorded into memory.

At 204, it may be determined whether a turn signal is activated, based on, e.g., a turn signal switch signal or a signal from any other automated system that has the capability to activate a turn signal. According to an exemplary embodiment, when the turn signal is not activated, then, at 202, signals from the one or more sensors and/or switches may be saved and recorded into memory.

According to an exemplary embodiment, when the turn signal is activated, then, at 206, it may be determined if a steering wheel angle is returned to center. According to an exemplary embodiment, determining whether the steering wheel angle is returned to center may be performed by checking whether the steering wheel angle crossed a threshold (Ex: ±50 deg) in a certain direction, based on the side of turn signal activation, and then returned to a center angle (e.g., a zero degree angle). According to an exemplary embodiment, when the steering wheel angle is returned to center, then, at 216, the turn signal may be deactivated on the side indicated by the turn signal.

According to an exemplary embodiment, when the steering wheel angle is not returned to center, then, at 208, it may be determined whether manual deactivation has been requested. According to an exemplary embodiment, determining whether manual deactivation has been requested may comprise determining whether a manual deactivation request of a turn signal is available and, when it is available, whether such a request is present. A manual deactivation may be requested using the turn signal activation mechanism and/or other suitable means. According to an exemplary embodiment, when a manual deactivation has been requested, then, at 216, the turn signal may be deactivated on the side indicated by the turn signal.

According to an exemplary embodiment, when a manual deactivation has not been requested, then, at 210, it may be determined whether a lane line crossing is detected. According to an exemplary embodiment, the determining whether a lane line crossing is detected may be performed by monitoring a status of a lane line offset position signal from one or more front view cameras on the side of turn signal activation. Determining whether a lane crossing has been detected is shown, in more detail, in FIG. 4B.

According to an exemplary embodiment, the left lane line offset from the vehicle (the distance between front view camera position in the windshield and the lane line on the left side of the vehicle) may be compared with half the vehicle width.

At 222, it is determined whether the left lane line offset is greater than half the vehicle width. When the left lane line offset is not greater than half the vehicle width, then, at 238, it is determined whether the turn signal is active.

When the turn signal is active, then the left lane line offset from the vehicle may be compared with half the vehicle width and, at 222, it is determined whether the left lane line offset is greater than half the vehicle width. When the turn signal is not active, then, at 246, a lane crossing is not detected.

When the left lane line offset is greater than half the vehicle width, then, at 224, the vehicle is construed as being within the left line, and a completion of step 1 is recorded.

At 226, it is determined whether the left lane line offset is less than half the vehicle width. When the left lane line offset is not less than half the vehicle width, then, at 240, it is determined whether the turn signal is active.

When the turn signal is active, then, at 224, the vehicle is construed as being within the left line, and a completion of step 1 is recorded. When the turn signal is not active, then, at 246, a lane crossing is not detected.

When the left lane line offset is less than half the vehicle width, then, at 228, it is construed that the left wheel has crossed the left line, and a completion of step 2 is recorded.

At 230, it is determined whether the right lane line offset (the distance between the front view camera position in the windshield and the right line on the right side of the vehicle) is less than half the vehicle width. When the right lane line offset is not less than half the vehicle width, then, at 242, it is determined whether the turn signal is active.

When the turn signal is active, then, at 228, it is construed that the left wheel has crossed the left line, and a completion of step 2 is recorded. When the turn signal is not active, then, at 246, a lane crossing is not detected.

When the right lane line offset is less than half the vehicle width, then, at 232, it is construed that the right wheel has not crossed the left line, and a completion of step 3 is recorded.

At 234, it is determined whether the right lane line offset is greater than half the vehicle width. When the right lane line offset is not greater than half the vehicle width, then, at 244, it is determined whether the turn signal is active.

When the turn signal is active, then, at 232, it is construed that the right wheel has not crossed the left line, and a completion of step 3 is recorded. When the turn signal is not active, then, at 246, a lane crossing is not detected.

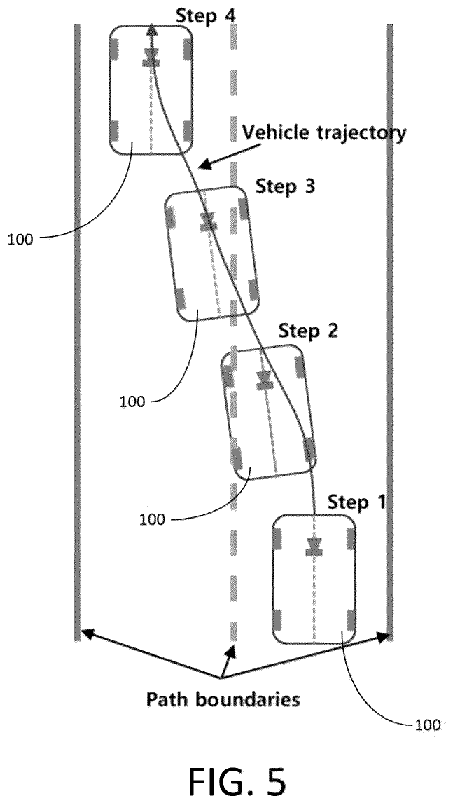

When the right lane line offset is greater than half the vehicle width, then, at 236, it is construed that a left lane line crossing has been detected and completed. Steps 1 through 4 are illustrated, by way of example, in FIG. 5.

Similarly, a right lane line crossing may be detected by similar logic, swapping the left lane line offset from the vehicle with the right lane line offset from the vehicle and vice-versa.

According to an exemplary embodiment, when a lane line crossing is detected, then, at 212, traversal velocity check logic may be performed. According to an exemplary embodiment, performing the traversal velocity check logic may comprise calculating the vehicle traversal velocity and waiting until the traversal velocity is within a threshold (e.g., 0.5 m/s) such that, in cases of higher traversal velocities (e.g., in instances of two or more lanes traversal), the turn signal remains activated. Performing the traversal velocity check logic is shown and described, in more detail, in FIG. 4C.

At 248, lane line curvature, provided by the front view camera sensor, may be compared with a threshold (e.g., +0.0005 l/m) to determine if the road line has significant curvature (i.e., if the lane line curvature is greater than a threshold). When the lane line curvature is greater than the threshold, then, at 250, the line curvature line curvature rate may be calculated based on the vehicle speed measurement available in the vehicle. This curvature rate may then, at 252, be subtracted from the vehicle yaw rate, measured by the vehicle's inertial measurement unit, to calculate the vehicle yaw rate with respect to the road line.

When the lane line curvature is not greater than the threshold, then, at 256, the measured yaw rate, measured by the vehicle's inertial measurement unit, may be used as the vehicle yaw rate with respect to the lane (road) line.

At 254, it may be determined whether the vehicle yaw rate with respect to the lane line is greater than a threshold by comparing the vehicle yaw rate against the threshold (e.g., +0.01 rad/s) to determine if the vehicle has rotational motion with respect to the lane line. When the vehicle yaw rate with respect to the lane line is greater than the threshold, the vehicle is determined to have rotational motion with respect to the lane line.

When the vehicle has rotational motion with respect to the lane line, then, at 258, a yaw rate-based lateral acceleration may be calculated based on the vehicle speed measurement available in the vehicle. This yaw rate-based lateral acceleration may, at 260, be subtracted from the lateral acceleration measured by the vehicle's inertial measurement unit to calculate traversal acceleration.

When the vehicle does not have rotational motion with respect to the lane line, then, at 266, the lateral acceleration measured by the vehicle's inertial measurement unit may be used as the traversal acceleration.

At 262, the traversal acceleration may be numerically integrated to calculate the traversal velocity, in accordance with Equation 1.

$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix} \qquad Equation 1$$

As shown in Equation 1, v_{t-y} is the local vehicle lateral velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s). K_{σ} is the lateral acceleration scaling factor (−), and k_{σ} is the road curvature gradient threshold (rad/s).

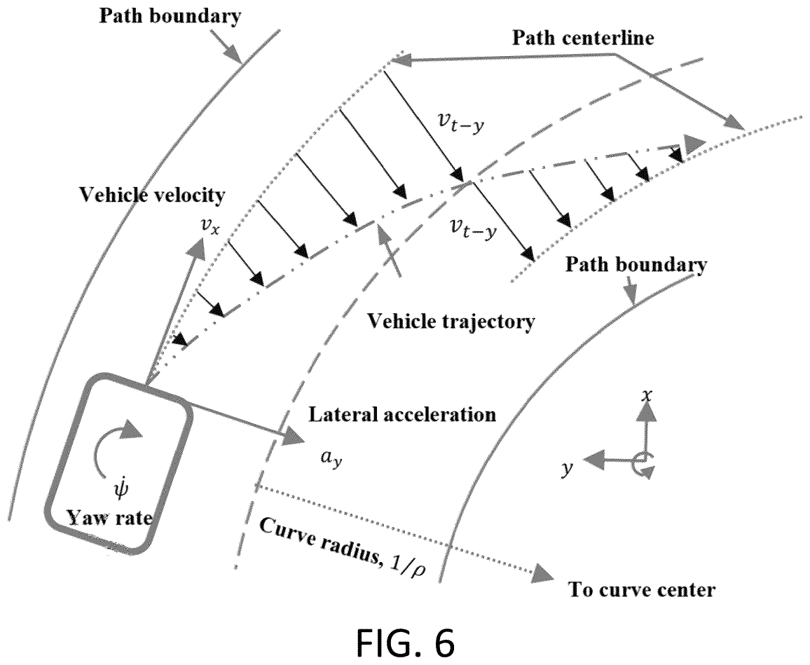

As shown, e.g., in FIG. 6, the traversal velocity is a local lateral vehicle velocity with which the vehicle may be laterally traversing with respect to the detected lane's (road's) centerline trajectory inferred from the road boundaries detected (e.g., via a camera and/or other suitable means) (equal to the numerical integration of local traversal acceleration). The traversal acceleration is a local lateral vehicle acceleration with which the vehicle is laterally traversing with respect to the road's centerline trajectory inferred from the road boundaries detected. The road line curvature is the instantaneous curvature (reciprocal of curve's radius) detected/calculated by the camera sensor. The filtered lateral acceleration is the filtered vehicle lateral acceleration as measured by the inertial measurement unit. The yaw rate is the vehicle's rotational motion (yaw) rate around a vertical axis, as measured by the inertial measurement unit. The longitudinal velocity is the distance travelled per unit time in the vehicle's longitudinal direction. The lateral acceleration scaling factor is the calibration parameter to scale/factor measured vehicle lateral acceleration value. The road curvature gradient threshold is the calibration parameter for road curvature gradient threshold.

The traversal velocity may be compared with a threshold (e.g., ±0.5 m/s) to determine, at 264, whether the traversal velocity is less than the threshold. When the traversal velocity is not less than the threshold, then, at 248, lane line curvature, provided by the front view camera sensor, may be compared with a threshold (e.g., ±0.0005 l/m) to determine if the road line has significant curvature.

When the traversal velocity is less than the threshold, then, at 214, the system may wait until an elapsed (delay) time is greater than a threshold time and, when the elapsed (delay) time is greater than the threshold time, then, at 216, the turn signal may be deactivated on the side indicated by the turn signal.

According to an exemplary embodiment, when a lane line crossing is not detected, then, at 218, lane line dynamics may be characterized by evaluating line information, such as curvature and heading, along with a deactivation event, such as consecutive occurrence of curvatures within certain thresholds and vehicle velocity within a certain threshold. Characterizing lane line dynamics is shown and described, in more detail, in FIG. 4D.

At 268, lane (road) line curvature (left or right side based on turn signal activation and various scenarios) may be compared against a threshold 1 (e.g., ±0.02 l/m) to determine whether the lane line curvature is greater than threshold 1.

When the lane line curvature is greater than threshold 1 and other conditions satisfy, then, at 270, the road line may be characterized as a roundabout.

When the lane line curvature is not greater than threshold 1 but other conditions satisfy, then, at 272, the lane line curvature is compared against another threshold (threshold 2) (e.g., ±0.01 l/m) to determine whether the lane line curvature is less than threshold 2.

When the lane line curvature is not less than threshold 2, then, at 268, the lane line curvature may be compared against threshold 1 (e.g., ±0.02 l/m) to determine whether the lane line curvature is greater than threshold 1.

When the lane line curvature is less than threshold 2 and other conditions satisfy, then, at 274, the difference between the left lane line heading rate and the right lane line heading rate may be compared against a threshold (e.g., 25 deg/s) to determine whether the difference between the left lane line heading rate and the right lane line heading rate is greater than the threshold. When the difference between the left lane line heading rate and the right lane line heading rate is greater than the threshold, the lane line may be characterized, at 276, as a scenario with a fork/split. When the difference between the left lane line heading rate and the right lane line heading rate is not greater than the threshold, the lane line may be characterized, at 278, as a scenario with a ramp.

Based on this characterization, it may be determined, at 220, whether a deactivation event is available. Determining whether a deactivation event is available is shown and described, in more detail, in FIG. 4E.

At 280, it may be determined whether a road fork/split detection is present. When a road split/fork detection is not present, then, at 284, it is determined whether a curved ramp detection is present.

When there is a road fork/split detection present, then, at 282, the vehicle heading rate with respect to the road line is compared against a threshold (e.g., ±25 deg/s) to determine whether the line heading rate is less than the threshold.

When the line heading rate is less than the threshold, it will be construed, at 296, as a deactivation event that may be used by logics downstream to turn off the turn signal. When the line heading rate is not less than the threshold, then, at 284, it is determined whether a curved ramp detection is present.

When a curved ramp detection is not present, then, at 290, it is determined whether a roundabout detection is present.

When a curved ramp detection is present, then, at 286, the road line offsets are compared against a threshold (e.g., vehicle width/2) to determine whether the line offset is greater than the threshold. When the line offset is not greater than the threshold, then, at 290, it is determined whether a roundabout detection is present.

When the line offset is greater than the threshold, then, at 288, the vehicle velocity is compared against another threshold to determine whether the vehicle velocity is greater than the threshold. When the vehicle velocity is greater than the threshold, it will be construed, at 296, as a deactivation event that may be used by logies downstream to turn off the turn signal. When the vehicle velocity is not greater than the threshold, then, at 290, it is determined whether a roundabout detection is present.

When the roundabout detection is not present, then, at 294, no deactivation event is detected. When a roundabout detection is present, then, at 292, the vehicle velocity may be compared against a threshold (e.g., 40 kph) to determine whether the vehicle velocity is less than the threshold.

When the vehicle velocity is not less than the threshold, then, at 294, no deactivation event is detected. When the vehicle velocity is less than the threshold, then, at 296, as a deactivation event that may be used by logics downstream to turn off the turn signal.

When a deactivation event is not available, then, at 206, it may be determined if a steering wheel angle is returned to center. When a deactivation event is available, then, at 216, the turn signal may be deactivated on the side indicated by the turn signal.

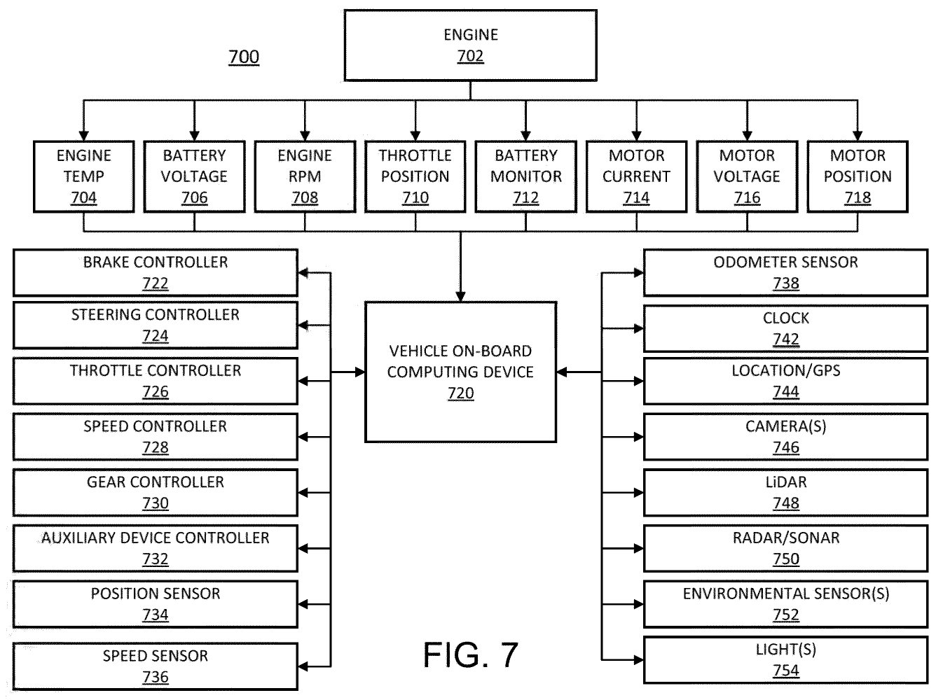

Referring now to FIG. 7, an example vehicle system architecture 700 for a vehicle is provided, in accordance with an exemplary embodiment of the present disclosure. The following discussion of vehicle system architecture 700 is sufficient for understanding one or more components of vehicle 100.

As shown in FIG. 7, the vehicle system architecture 700 may comprise an engine, motor or propulsive device 702 and various sensors 704-718 for measuring various parameters of the vehicle system architecture 700. In gas-powered or hybrid vehicles having a fuel-powered engine, the sensors 704-718 may comprise, for example, an engine temperature sensor 704, a battery voltage sensor 706, an engine Rotations Per Minute (RPM) sensor 708, and/or a throttle position sensor 710. If the vehicle is an electric or hybrid vehicle, then the vehicle may comprise an electric motor, and accordingly may comprise sensors such as a battery monitoring system 712 (to measure current, voltage and/or temperature of the battery), motor current 714 and voltage 716 sensors, and motor position sensors such as resolvers and encoders 718.

Operational parameter sensors that are common to both types of vehicles may comprise, for example: a position sensor 734 such as an accelerometer, gyroscope and/or inertial measurement unit; a speed sensor 736; and/or an odometer sensor 738. The vehicle system architecture 700 also may comprise a clock 742 that the system uses to determine vehicle time and/or date during operation. The clock 742 may be encoded into the vehicle on-board computing device 720, it may be a separate device, or multiple clocks may be available.

The vehicle system architecture 700 may comprise various sensors that operate to gather information about the environment in which the vehicle is traveling. These sensors may comprise, for example: a location sensor 744 (for example, a Global Positioning System (GPS) device); object detection sensors such as one or more cameras 746; a LiDAR sensor system 748; and/or a radar and/or a sonar system 750. The sensors may comprise environmental sensors 752 such as, e.g., a humidity sensor, a precipitation sensor, a light sensor, and/or ambient temperature sensor. The object detection sensors may be configured to enable the vehicle system architecture 700 to detect objects that are within a given distance range of the vehicle in any direction, while the environmental sensors 752 may be configured to collect data about environmental conditions within the vehicle's area of travel. According to an exemplary embodiment, the vehicle system architecture 700 may comprise one or more lights 754 (e.g., headlights, flood lights, flashlights, etc.).

During operations, information may be communicated from the sensors to an on-board computing device 720 (e.g., computing device 135, computing device 800). The on-board computing device 720 may be configured to analyze the data captured by the sensors and/or data received from data providers and may be configured to optionally control operations of the vehicle system architecture 700 based on results of the analysis. For example, the on-board computing device 720 may be configured to control: braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers. The brake controller 722 may comprise a pedal effort sensor, pedal effort sensor, and/or simulator temperature sensor, as described herein.

Geographic location information may be communicated from the location sensor 744 to the on-board computing device 720, which may then access a map of the environment that corresponds to the location information to determine known fixed features of the environment such as streets, buildings, stop signs and/or stop/go signals. Captured images from the cameras 746 and/or object detection information captured from sensors such as LiDAR 748 may be communicated from those sensors to the on-board computing device 720. The object detection information and/or captured images may be processed by the on-board computing device 720 to detect objects in proximity to the vehicle. Any known or to be known technique for making an object detection based on sensor data and/or captured images may be used in the embodiments disclosed in this document.

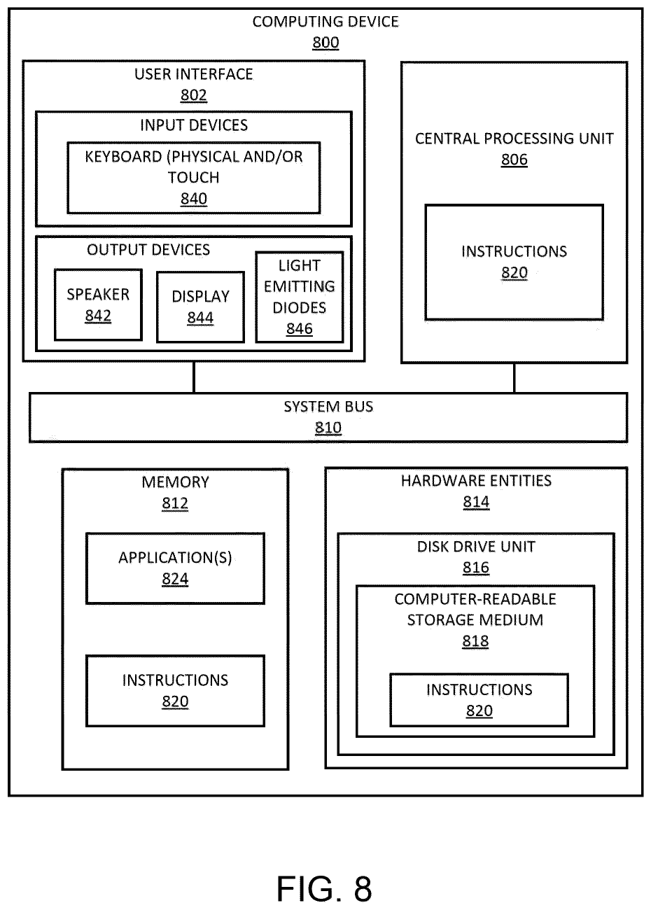

Referring now to FIG. 8, an illustration of an example architecture for a computing device 500 is provided. According to an exemplary embodiment, one or more functions of the present disclosure may be implemented by a computing device such as, e.g., computing device 800 or a computing device similar to computing device 800. Computing device 800 may be a quantum computer, a classical computer, and/or have one or more components configured to perform one or more quantum and/or classical computing functions. Computing device 135 and/or computing device 720 may be an example of computing device 800 and/or may comprise one or more components of computing device 800.

The hardware architecture of FIG. 8 represents one example implementation of a representative computing device configured to implement at least a portion of the systems/devices (e.g., vehicle 100) and method(s)/control logic(s) (e.g., method 200) described herein.

Some or all components of the computing device 800 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 8, the computing device 800 may comprise a user interface 802 (e.g., a graphical user interface), a Central Processing Unit (“CPU”) 806, a system bus 810, a memory 812 connected to and accessible by other portions of computing device 800 through system bus 810, and hardware entities 814 connected to system bus 810. The user interface may comprise input devices and output devices, which may be configured to facilitate user-software interactions for controlling operations of the computing device 800. The input devices may comprise, but are not limited to, a physical and/or touch keyboard 840. The input devices may be connected to the computing device 800 via a wired or wireless connection (e.g., a Bluetooth® connection). The output devices may comprise, but are not limited to, a speaker 842, a display 844, and/or light emitting diodes 846.

At least some of the hardware entities 814 may be configured to perform actions involving access to and use of memory 812, which may be a Random Access Memory (RAM), a disk driver and/or a Compact Disc Read Only Memory (CD-ROM), among other suitable memory types. Hardware entities 814 may comprise a disk drive unit 816 comprising a computer-readable storage medium 818 on which may be stored one or more sets of instructions 820 (e.g., programming instructions such as, but not limited to, software code) configured to implement one or more of the methodologies, procedures, or functions described herein. The instructions 820 may also reside, completely or at least partially, within the memory 812 and/or within the CPU 806 during execution thereof by the computing device 800.

The memory 812 and the CPU 806 may also constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding, or carrying a set of instructions 820 for execution by the computing device 800 and that cause the computing device 800 to perform any one or more of the methodologies of the present disclosure. According to various embodiments, one or more computer applications 824 may be stored on the memory 812.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for deactivating one-touch turn signals as a function of vehicle traversal velocity, comprising:
using a computing device comprising a processor and a memory:
determining, using a turn signal switch, whether a turn signal of a vehicle is activated;
determining whether a lane crossing is detected; and
when a lane crossing is detected:
calculating a vehicle traversal velocity;
comparing the traversal velocity to a first threshold; and
when the traversal velocity is less than the first threshold, deactivating the turn signal when an elapsed time is greater than a second threshold.

2. The method of claim 1, further comprising, prior to determining whether the lane crossing is detected:
determining whether a steering wheel angle is returned to center; and
when the steering wheel angle is not returned to center, determining whether manual deactivation of the turn signal is requested.

3. The method of claim 1, wherein determining whether the lane crossing is detected comprises:
determining whether a first wheel of the vehicle is within a lane line on a road;
determining whether the first wheel has crossed the lane line when the first wheel of the vehicle is determined to be within the lane line;
determining whether a second wheel has crossed the lane line when the first wheel is determined to have crossed the lane line; and
detecting a lane crossing when the first wheel and the second wheel are determined to have crossed the lane line.

4. The method of claim 1, wherein calculating the vehicle traversal velocity comprises:
determining, using the computing device, an inertial measurement unit, and one or more cameras:
a vehicle lateral acceleration;
a vehicle yaw rate;
a land line curvature; and
a vehicle longitudinal velocity; and
calculating the vehicle traversal velocity, according to:
$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$
wherein:
v_{t-y} is the local vehicle traversal velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and kg is the road curvature gradient threshold (rad/s).

5. The method of claim 1, further comprising, when the lane crossing is not detected, characterizing lane line dynamics, wherein characterizing lane line dynamics comprises:
determining whether the lane lines conform to a roundabout;
when the lane lines conform to a roundabout, characterizing the lane lines as a roundabout;
determining whether the lane lines conform to a fork/split;
when the lane lines conform to a fork/split, characterizing the lane lines as a fork/split;
determining whether the lane lines conform to a ramp; and
when the lane lines conform to a ramp, characterizing the lane lines as a ramp.

6. The method of claim 5, further comprising, after characterizing the lane line dynamics, determining whether a deactivation event is detected.

7. The method of claim 6, further comprising, when a deactivation event is detected, deactivating the turn signal when the elapsed time is greater than the second threshold.

8. A system for deactivating one-touch turn signals as a function of vehicle traversal velocity, comprising:
a vehicle, comprising:
a turn signal switch configured to activate a turn signal; and
a computing device comprising a processor and a memory, wherein the computing device is configured to:
determine, using a turn signal switch, whether a turn signal of a vehicle is activated;
determine whether a lane crossing is detected; and
when a lane crossing is detected:
calculate a vehicle traversal velocity;
compare the traversal velocity to a first threshold; and
when the traversal velocity is less than the first threshold, deactivate the turn signal when an elapsed time is greater than a second threshold.

9. The system of claim 8, wherein:
the vehicle further comprises a steering wheel; and
the computing device, prior to determining whether the lane crossing is detected, is configured to:
determine whether a steering wheel angle is returned to center; and
when the steering wheel angle is not returned to center, determine whether manual deactivation of the turn signal is requested.

10. The system of claim 8, wherein the determining whether the lane crossing is detected comprises:
determining whether a first wheel of the vehicle is within a lane line on a road;
determining whether the first wheel has crossed the lane line when the first wheel of the vehicle is determined to be within the lane line;
determining whether a second wheel has crossed the lane line when the first wheel is determined to have crossed the lane line; and
detecting a lane crossing when the first wheel and the second wheel are determined to have crossed the lane line.

11. The system of claim 8, wherein:
the vehicle further comprises an inertial measurement unit and one or more cameras; and
calculating the vehicle traversal velocity comprises:
determining, using the computing device, an inertial measurement unit, and one or more cameras:
a vehicle lateral acceleration;
a vehicle yaw rate;
a land line curvature; and
a vehicle longitudinal velocity; and
calculating the vehicle traversal velocity, according to:
$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$
wherein:
v_{t-y} is the local vehicle traversal velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and k_{σ} is the road curvature gradient threshold (rad/s).

12. The system of claim 8, wherein the computing device is further configured, when the lane crossing is not detected, to characterize lane line dynamics, wherein characterizing lane line dynamics comprises:
determining whether the lane lines conform to a roundabout;
when the lane lines conform to a roundabout, characterizing the lane lines as a roundabout;
determining whether the lane lines conform to a fork/split;
when the lane lines conform to a fork/split, characterizing the lane lines as a fork/split;
determining whether the lane lines conform to a ramp; and
when the lane lines conform to a ramp, characterizing the lane lines as a ramp.

13. The device of claim 12, wherein the computing device is further configured to determine, after characterizing the lane line dynamics, whether a deactivation event is detected.

14. The device of claim 14, wherein the computing device is further configured to deactivate, when a deactivation event is detected, the turn signal when the elapsed time is greater than the second threshold.

15. A system for deactivating one-touch turn signals as a function of vehicle traversal velocity, comprising:
a turn signal switch configured to activate a turn signal; and
a computing device comprising a processor and a memory, wherein the memory is configured to store instructions that, when executed by the processor, are configured to cause the processor to:
determine, using a turn signal switch, whether a turn signal of a vehicle is activated;
determine whether a lane crossing is detected; and
when a lane crossing is detected:
calculate a vehicle traversal velocity;
compare the traversal velocity to a first threshold; and
when the traversal velocity is less than the first threshold, deactivate the turn signal when an elapsed time is greater than a second threshold.

16. The system of claim 15, wherein the instructions, when executed by the processor, are further configured to cause the processor to:
determine whether a steering wheel angle is returned to center; and
when the steering wheel angle is not returned to center, determine whether manual deactivation of the turn signal is requested.

17. The system of claim 15, wherein the determining whether the lane crossing is detected comprises:
determining whether a first wheel of the vehicle is within a lane line on a road;
determining whether the first wheel has crossed the lane line when the first wheel of the vehicle is determined to be within the lane line;
determining whether a second wheel has crossed the lane line when the first wheel is determined to have crossed the lane line; and
detecting a lane crossing when the first wheel and the second wheel are determined to have crossed the lane line.

18. The system of claim 15, wherein calculating the vehicle traversal velocity comprises:
determining, using the computing device, an inertial measurement unit, and one or more cameras:
a vehicle lateral acceleration;
a vehicle yaw rate;
a land line curvature; and
a vehicle longitudinal velocity; and
calculating the vehicle traversal velocity, according to:
$${v}_{t - y} = \{ \begin{matrix}\int ( {K}_{σ} {a}_{y} - ( \dot{ψ} - {v}_{x} * σ ) * {v}_{x} ) , & \vert {v}_{x} * σ \vert \leq {k}_{σ} \\ \int ( {K}_{σ} {a}_{y} + sgn ( σ ) * sgn ( \dot{ψ} ) - ( \dot{ψ} - {v}_{x} * σ ) * {v}_{x} ) , & \vert {v}_{x} * σ \vert > {k}_{σ}\end{matrix}$$
wherein:
v_{t-y} is the local vehicle traversal velocity (m/s), a_{y} is the filtered vehicle lateral acceleration (m/s²), \dot{ψ} is the vehicle yaw rate (rad/s), σ is the land line curvature (l/m), vₓ is the vehicle longitudinal velocity (m/s), K_{σ} is the lateral acceleration scaling factor (−), and k_{σ} is the road curvature gradient threshold (rad/s).

19. The system of claim 15, wherein the instructions, when executed by the processor, are further configured to cause the processor, when the lane crossing is not detected, to characterize lane line dynamics, wherein characterizing lane line dynamics comprises:
determining whether the lane lines conform to a roundabout;
when the lane lines conform to a roundabout, characterizing the lane lines as a roundabout;
determining whether the lane lines conform to a fork/split;
when the lane lines conform to a fork/split, characterizing the lane lines as a fork/split;
determining whether the lane lines conform to a ramp; and
when the lane lines conform to a ramp, characterizing the lane lines as a ramp.

20. The device of claim 19, wherein the instructions, when executed by the processor, are further configured to cause the processor to:
determine, after characterizing the lane line dynamics, whether a deactivation event is detected; and
deactivate, when a deactivation event is detected, the turn signal when the elapsed time is greater than the second threshold.
